(19) United States
(12) Patent Application Publication
(10) Pub. No.: US 2022/0129810 A1
(43) Pub. Date: Apr. 28, 2022

(54) MACHINE LEARNING FOR VEHICLE ALLOCATION

(71) Applicant: DriverDo LLC, Overland Park, KS (US)

(72) Inventors: Mashhur Zarif Haque, Lawrence, KS (US); Kyri Elyse Barton, Olathe, KS (US); Kevin Michael Burke, Lenexa, KS (US)

(21) Appl. No.: 17/508,713

(22) Filed: Oct. 22, 2021

Related U.S. Application Data
(60) Provisional application No. 63/104,582, filed on Oct. 23, 2020.

(51) Int. Cl. G06Q 10/06; G06N 3/08; G06N 3/04

(52) U.S. Cl. CPC G06Q 10/06311; G06N 3/0445; G06N 3/08

(57) ABSTRACT

Media, method and system for generating an itinerary using machine learning. To accomplish this, a reinforcement learning model is trained on historical data of past trips taken and their corresponding costs. The reinforcement learning model uses a self-play algorithm to train itself to generate itineraries which minimize the cost. The reinforcement learning model is then used to train a supervised learning model. The trained supervised learning model is given a set of input requirements and generates as an output an itinerary to send to a user.

### RELATED APPLICATIONS

This non-provisional application claims the benefit of priority from U.S. Provisional Application Ser. No. 63/104,582, filed Oct. 23, 2020 entitled “Machine Learning for Vehicle Allocation.”

This non-provisional patent application shares certain subject matter with earlier-filed U.S. patent application Ser. No. 14/084,380, filed Nov. 19, 2013 and entitled ALLOCATION SYSTEM AND METHOD OF DEPLOYING RESOURCES, U.S. patent application Ser. No. 14/485,367, filed Sep. 12, 2014 and entitled DIGITAL VEHICLE TAG AND METHOD OF INTEGRATION IN VEHICLE ALLOCATION SYSTEM, U.S. patent application Ser. No. 15/010,039, filed Jan. 29, 2016 and entitled TRIP SCHEDULING SYSTEM, U.S. patent application Ser. No. 15/905,171, filed Feb. 26, 2018 and entitled DIGITAL VEHICLE TAG AND METHOD OF INTEGRATION IN VEHICLE ALLOCATION SYSTEM, and U.S. patent application Ser. No. 16/105,559, filed Aug. 28, 2018 and entitled DIGITAL VEHICLE TAG AND METHOD OF INTEGRATION IN VEHICLE ALLOCATION SYSTEM. The identified earlier-filed patent applications are hereby incorporated by reference in their entirety into the present application.

### BACKGROUND

### 1. Field

Embodiments of the invention generally relate to scheduling trips for transporting vehicles (or other goods) from one location to another and, more particularly, to methods and systems for using a machine learning model to allocate drivers to vehicles and assigning tasks to be completed for each segment of the journey.

### 2. Related Art

Traditionally, transportation of vehicles between locations (for example, from the auction where they are purchased to a dealership for resale) have been transported either by car carrier or by employing a driver to travel to the pickup location and drive the vehicle to the drop-off location. In the latter case, the driver must be transported to the pickup location and from the drop-off location, typically by a second driver in a chase car. However, this leads to inefficiencies as two drivers are required and the total distance traveled is typically at least twice the distance from the pickup point to the drop-off point. Particularly in the case where many vehicles must be transported from a variety of pickup points to a variety of destinations, such inefficiencies can be prohibitively expensive in terms of time and costs. Historically, such scheduling is done by designated employees and may introduce variance and limited cost savings. Accordingly, there is a need for a system that can automatically schedule drivers for trips between locations so as to minimize the distance traveled, the number of drivers, and the time needed, which leads to minimized overhead costs.

### SUMMARY

Embodiments of the invention address the above-described need by providing methods and systems for using a machine learning model to automatically allocate drivers to vehicles for each segment of a desired trip and to generate an itinerary for those drivers, automatically determining any needed chase car capacity. The problem of temporally-constrained optimal task allocation and sequencing is NP-hard, with full solutions scaling exponentially with the number of factors involved. Accordingly, such problems require domain-specialized knowledge for good heuristics or approximation algorithms. Applications in this domain can be used to solve such combinatorial problems as the traveling salesman, job-shop scheduling, multi-vehicle routing, multi-robot task allocation, and large-scale distributed parallel processing, among many others. Once a reinforcement learning model is trained, the reinforcement learning model can be used to train a supervised learning model. This ensemble method provides better predictive performance than would otherwise be obtained from any individual learning algorithm alone and allows the supervised learning model to use what was learned from the reinforcement learning model in a simplified and direct input-output approach.

In a first embodiment, the invention includes a system for generating a vehicle transportation itinerary comprising a first server programmed to receive historical data comprising a series of vehicle trips comprising a starting location, an ending location, and a distance traveled, train a reinforcement learning model to generate a schedule based on a cost function associated with the schedule, wherein the reinforcement learning model is trained on the historical data using a self-play algorithm, use the reinforcement learning model to generate a plurality of schedules, train a supervised learning model using the historical data and the plurality of schedules, generate the itinerary using the supervised learning model by providing it with a set of input requirements, wherein the set of input requirements comprises a plurality of geographic coordinates and a map of the road network between the geographic coordinates, and send the itinerary to a user.

In a second embodiment, the invention includes one or more non-transitory computer-readable media storing computer-executable instructions that, when executed by a processor, perform a method of generating a vehicle transportation itinerary, the method comprising the steps of receiving historical data comprising a series of vehicle trips comprising a starting location, an ending location, and a distance traveled, training a reinforcement learning model to generate a schedule based on a cost function associated with the schedule, wherein the reinforcement learning model is trained on the historical data using a self-play algorithm, using the reinforcement learning model to generate a plurality of schedules, training a supervised learning model using the historical data and the plurality of schedules, generating the itinerary using the supervised learning model by providing it with a set of input requirements, wherein the set of input requirements comprises a plurality of geographic coordinates and a map of the road network between the geographic coordinates, and sending the itinerary to a user.

In a third embodiment the invention includes a method of generating a vehicle transportation itinerary comprising the steps of receiving historical data comprising a series of vehicle trips comprising a starting location, an ending location, and a distance traveled, training a reinforcement learning model to generate a schedule based on a cost function associated with the schedule, wherein the reinforcement learning model is trained on the historical data using a self-play algorithm, using the reinforcement learning model to generate a plurality of schedules, training a supervised learning model using the historical data and the plurality of schedules, generating the itinerary using the supervised learning model by providing it with a set of input requirements, wherein the set of input requirements comprises a plurality of geographic coordinates and a map of the road network between the geographic coordinates, and sending the itinerary to a user.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE DRAWING FIGURES

Embodiments of the invention are described in detail below with reference to the attached drawing figures, wherein:

FIG. 1 depicts an exemplary hardware platform that for certain embodiments of the invention;

FIG. 2 depicts an exemplary scenario in which an itinerary would be generated;

FIG. 3 depicts an exemplary flow chart for illustrating the operation of a method in accordance with one embodiment of the invention;

FIG. 4 depicts a schematic diagram of an embodiment for generating an itinerary; and

FIG. 5 depicts a driver interface in accordance with embodiments of the invention.

The drawing figures do not limit the invention to the specific embodiments disclosed and described herein. The drawings are not necessarily to scale, emphasis instead being placed upon clearly illustrating the principles of the invention.

### DETAILED DESCRIPTION

At a high level, embodiments of the invention generate an itinerary for a driver using an ensemble machine learning method. For example, if a car needs to be picked up from an auction, taken through a car wash, taken to a mechanic, and then taken to a dealership, the system will optimize the itinerary for a driver such that all of these tasks can be completed with minimal overhead. The driver may be instructed to wait at the mechanic until the work is completed, avoiding the need for a chase car. Alternately, if it is more efficient, the driver may be instructed to travel to a different location, for example using a rideshare application, and conduct an additional trip before returning to the mechanic. The ensemble machine learning model will ultimately generate the itinerary that, taking all of these factors into account, is the most efficient. Although this specification describes the invention with respect to transporting vehicles, it will be appreciated that embodiments of the invention can include other forms of transportation including transportation of passengers or goods. Broadly, the invention is applicable to any industry that can increase efficiencies by optimizing schedules.

In order to determine which possible itinerary for the trip is the most efficient, the requirements are input into a supervised learning model which generates an itinerary as an output. The supervised learning model will have been trained by a self-play reinforcement learning model which was trained on historical data. This allows for the supervised learning model to have the benefits of the knowledge of the self-play reinforcement learning model while still providing a simple output based on the input requirements.

More generally, embodiments of the invention as described above can be combined with the other concepts disclosed in this specification and the related applications incorporated above to form an integrated and efficient trip management system. In particular, if a driveaway company previously wished to transport a vehicle, the driveaway company would need to make separate arrangements for each vehicle for a driver, including coordinating all of the individual stops that the vehicle would need to make.

Embodiments of the invention allow a driver to efficiently be assigned an itinerary for driving vehicles including locations for pick-up, stop, and drop-off for each vehicle. The system can automatically determine the most cost-efficient itinerary which satisfies the specified requirements. The system can react to additional input requirements to continuously optimize the itinerary for one or more drivers. The system can also provide the driver with turn-by-turn navigation for the generated itinerary, further improving the efficiency of the system.

The subject matter of embodiments of the invention is described in detail below to meet statutory requirements; however, the description itself is not intended to limit the scope of claims. Rather, the claimed subject matter might be embodied in other ways to include different steps or combinations of steps similar to the ones described in this document, in conjunction with other present or future technologies. Minor variations from the description below will be obvious to one skilled in the art, and are intended to be captured within the scope of the claimed invention. Terms should not be interpreted as implying any particular ordering of various steps described unless the order of individual steps is explicitly described.

The following detailed description of embodiments of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of embodiments of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate reference to “one embodiment” “an embodiment,” or “embodiments” in this description do not necessarily refer to the same embodiment and are also not mutually exclusive unless so stated and/or except as will be readily apparent to those skilled in the art from the description. For example, a feature, structure, or act described in one embodiment may also be included in other embodiments, but is not necessarily included. Thus, the technology can include a variety of combinations and/or integrations of the embodiments described herein.

### Operational Environment for Embodiments of the Invention

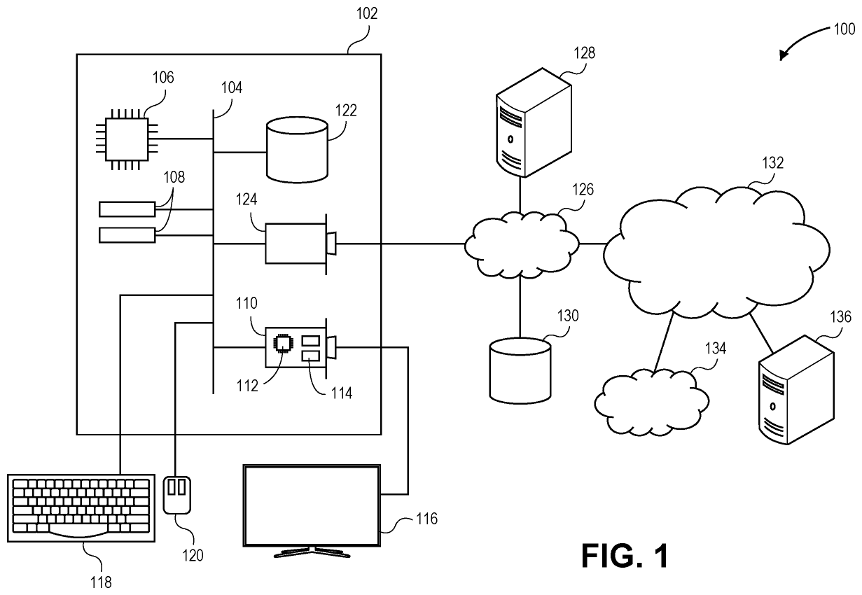

Turning first to FIG. 1, an exemplary hardware platform that for certain embodiments of the invention is depicted. Computer 102 can be a desktop computer, a laptop computer, a server computer, a mobile device such as a smartphone or tablet, or any other form factor of general- or special-purpose computing device. Depicted with computer 102 are several components, for illustrative purposes. In some embodiments, certain components may be arranged differently or absent. Additional components may also be present. Included in computer 102 is system bus 104, whereby other components of computer 102 can communicate with each other. In certain embodiments, there may be multiple busses or components that may communicate with each other directly. Connected to system bus 104 is central processing unit (CPU) 106. Also attached to system bus 104 are one or more random-access memory (RAM) modules. Also attached to system bus 104 is graphics card 110. In some embodiments, graphics card 104 may not be a physically separate card, but rather may be integrated into the motherboard or the CPU 106. In some embodiments, graphics card 110 has a separate graphics-processing unit (GPU) 112, which can be used for graphics processing or for general purpose computing (GPGPU). Also on graphics card 110 is GPU memory 114. Connected (directly or indirectly) to graphics card 110 is display 116 for user interaction. In some embodiments no display is present, while in others it is integrated into computer 102. Similarly, peripherals such as keyboard 118 and mouse 120 are connected to system bus 104. Like display 116, these peripherals may be integrated into computer 102 or absent. Also connected to system bus 104 is local storage 122, which may be any form of computer-readable media, and may be internally installed in computer 102 or externally and removably attached.

Computer-readable media include both volatile and nonvolatile media, removable and non-removable media, and contemplate media readable by a database. For example, computer-readable media include (but are not limited to) RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data temporarily or permanently. However, unless explicitly specified otherwise, the term “computer-readable media” should not be construed to include physical, but transitory, forms of signal transmission such as radio broadcasts, electrical signals through a wire, or light pulses through a fiber-optic cable. Examples of stored information include computer-usable instructions, data structures, program modules, and other data representations.

Finally, network interface card (NIC) 124 is also attached to system bus 104 and allows computer 102 to communicate over a network such as network 126. NIC 124 can be any form of network interface known in the art, such as Ethernet, ATM, fiber, Bluetooth, or Wi-Fi (i.e., the IEEE 802.11 family of standards). NIC 124 connects computer 102 to local network 126, which may also include one or more other computers, such as computer 128, and network storage, such as data store 130. Generally, a data store such as data store 130 may be any repository from which information can be stored and retrieved as needed. Examples of data stores include relational or object oriented databases, spreadsheets, file systems, flat files, directory services such as LDAP and Active Directory, or email storage systems. A data store may be accessible via a complex API (such as, for example, Structured Query Language), a simple API providing only read, write and seek operations, or any level of complexity in between. Some data stores may additionally provide management functions for data sets stored therein such as backup or versioning. Data stores can be local to a single computer such as computer 128, accessible on a local network such as local network 126, or remotely accessible over Internet 132. Local network 126 is in turn connected to Internet 132, which connects many networks such as local network 126, remote network 134 or directly attached computers such as computer 136. In some embodiments, computer 102 can itself be directly connected to Internet 132.

### Embodiments of the Invention in Operation

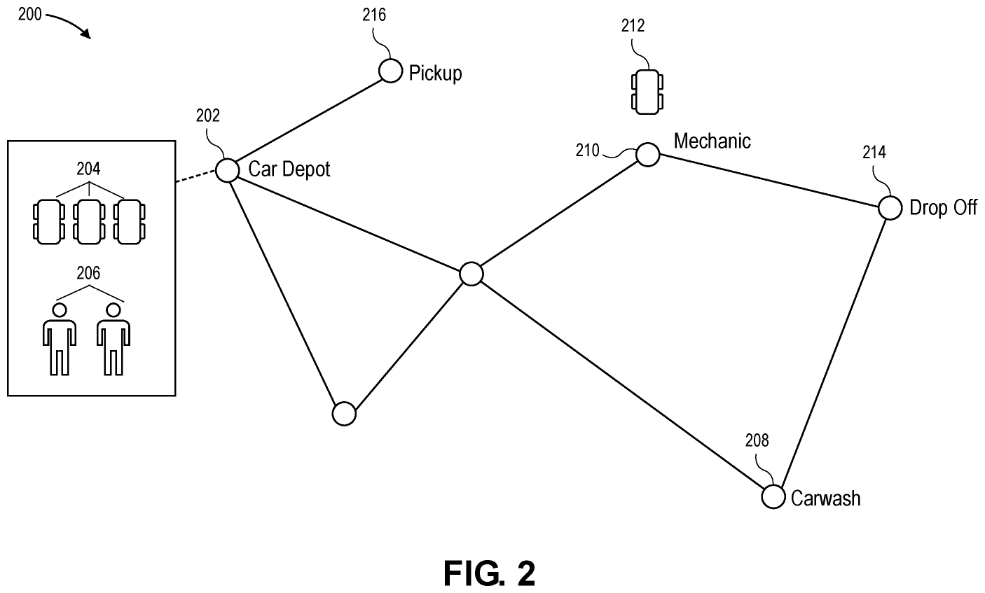

Turning now to FIG. 2, an exemplary scenario in which an itinerary would be generated is depicted, and referred to generally by reference numeral 200. The owner of a fleet of vehicles, such as a car dealership, may require moving a plurality of cars to and from a plurality of locations. Such movements are facilitated by drivers. An itinerary must be generated for each driver to inform the driver where they will need to travel, which cars they will be driving, and which, if any, stops they will need to make on the way to the destination.

In some embodiments, a driver may be required to travel to a car depot 202 to begin the itinerary. A car depot 202 may be, for example, a dealership, rental car location, or any other location at which one or more cars 204 may be present. The car depot 202 may contain one or more cars 204, one or more of which may need to be relocated to a different location. The car depot 202 may also have one or more drivers 206 present for driving the cars 204 to each car's destination. In some embodiments, the driver 206 may be required to drive their own car to the car depot 202 to begin the itinerary. In other embodiments, the driver 206 will receive a ride to the car depot 202. In further embodiments, the driver 206 may receive a ride to the car depot 203 via a rideshare application, via public transportation, or via another driver.

In some embodiments, a car 204 may have a drop off 214 location which acts as a destination. In some embodiments, the drop off 214 location may be a different dealership, rental car lot, or a person's house. The drop off 214 location is the last stop for a car 204 on a driver's itinerary. In some embodiments, the drop off 314 location will also be the last item on a driver's itinerary, though in other embodiments the driver will continue to another location and complete an additional trip with an additional car.

In some embodiments, the driver 206 may need to make one or more stops before the drop off. For example, the driver 206 may need to go through a carwash 208 before dropping off the car. Alternatively or in addition, the driver 206 may need to take the car to a mechanic 210 before dropping off the car. Still further, the driver may need to make stops to pick up other drivers and to drop them off at locations to allow the other drivers to complete trips.

In some embodiments, the driver 206 may need to travel to a pickup 216 location to obtain a car. In some embodiments, the driver 206 may need to ride with a second driver 206 to the pickup 216 location. In further embodiments, the driver 206 may use a rideshare application to travel to the pickup 216 location, the driver 206 may ride with another drive to the pickup 216 location, or the driver 206 may take public transit to the pickup 216 location. In still further embodiments, the driver 206 may then drive a car back from the pickup 216 location.

In some embodiments, the mechanic 210 may be a pickup 216 location. In some embodiments, a repaired car 212 may be located at the mechanic. A driver 206 may need to travel to a mechanic 212 to then drive a repaired car 212 to a drop off location. In other embodiments, the driver 206 may take a car 204 from the car depot 202 to the mechanic 210 and wait until the car 204 is repaired.

In some embodiments, an itinerary may be improved for a driver by combining two separate activities into one longer activity. For example, a first trip's drop off 214 location may be a second trip's pickup 216 location. In further embodiments, multiple trips can be combined in a particular geo-fenced region. In still further embodiments, an itinerary may be improved by grouping multiple individuals into vehicles together when those individuals are traveling in a similar geographic location. In additional embodiments, the use of ride sharing services may be reduced or eliminated. Itineraries may even further be improved by considering external factors which may further improve the quality of an itinerary. For example, the hours of a particular location, such as a gas station or mechanic 212, may be considered. Additional external factors such as events which may occur on the roads connecting the geographic locations may also be considered.

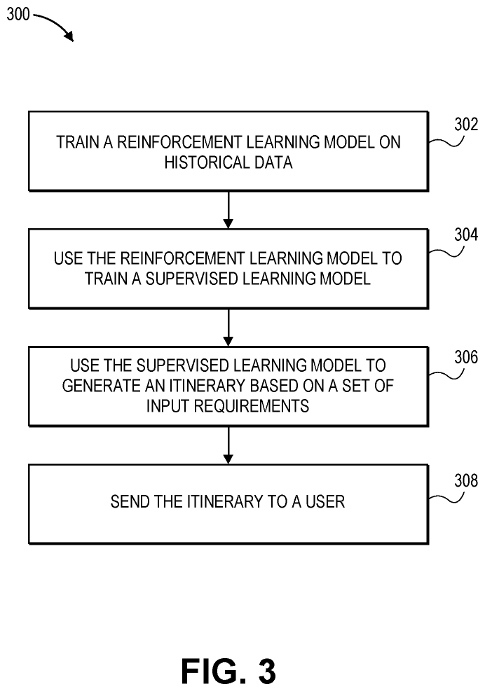

Turning now to FIG. 3, an exemplary flow chart is depicted illustrating the operation of a method 300 for generating an itinerary and sending it to a user. At step 302, a reinforcement learning model is trained on historical data. In some embodiments, the historical data is based on prior itineraries generated for the moving of vehicles. In further embodiments, the historical data may be limited to specific date ranges, may be limited to specific companies, or may otherwise be restricted to generate a more specific reinforcement learning model. In some embodiments, the reinforcement learning model may use a deep neural network.

In some embodiments, the problem may be constructed similar to traditional two-player games which have been the subject of much study and machine learning model development. For example, such models have been used to play Go at a level surpassing human players. In these models, a board is constructed showing the current state of the game. Each of the two players, which may be represented by black and white, take turns playing a move. Likewise, in some of the present embodiments, the board may represent a series of geographic locations and the path, distance, or cost between some of the geographic locations, which forms a graph. The board may also include information about one or more drivers, and the location of the one or more drivers. Each move on the board may correspond to a possible trip that a driver may take. An individual game corresponds to the white and black player, which may represent two different machine learning models, competing against each other to generate itineraries for a series of boards. The games may be scored based on a cost function associated with each itinerary, with the winning model determined as the model which generates the itineraries with the lower cost. For example, the cost function may be a total distance travelled, a total time to complete the itinerary, a total number of driver-hours used to complete the itinerary, a total monetary cost associated with the itinerary, or any other cost function.

In some embodiments, a deep neural network takes a raw board representation containing a current player position and a history as an input, and then outputs a probability distribution over possible moves and a corresponding value. This probability distribution gives the likelihood of a particular move being selected given the player's current position. In some embodiments, this model combines the policy and value neural networks, consisting of multiple residual blocks of convolutional layers with batch normalization and rectifier non-linearities.

In some embodiments, training the reinforcement learning model on historical data involves using a Monte-Carlo Tree Search (MCTS). In other embodiments, any suitable randomized algorithms and/or minimax algorithms may be used. In some embodiments, the MCTS can be used to traverse a game tree, wherein game states are semi-randomly walked down and expanded, and statistics are gathered about the frequency of moves and underlying game outcomes. In further embodiments, training the reinforcement learning model on historical data involves using a neural-network-guided MCTS at every position within each game-play. The MCTS performs multiple simulations guided by the neural network to improve the model by generating probabilities of playing each move that yield higher performance than the raw neural network move probabilities. The MCTS may be referred to as the policy improvement operator, with the game winner being referred to as the policy evaluation operator. In further embodiments, the MCTS may use additional local maxima detection algorithms.

In some embodiments, the MCTS performs multiple simulations guided by a neural network. The neural network is referred to as fe . Each edge (s,a) in the search tree stores a prior probability P(s,a), a visit count N(s,a), and an action-value Q(s,a). Simulations begin from the root state and iteratively select moves that maximize an upper confidence bound. The upper confidence bound is represented as Q(s,a)+U(s,a), where U(s,a)∝P(s,a)/(1+N(s,a)). The moves are iteratively selected until a leaf node s′ is found. This leaf position is then expanded and evaluated once by the network to generate prior probabilities and evaluation. The evaluation is represented as (P(s′,·),V(s′))=f_{θ}(s′). Each edge (s,a) traversed in the simulation is updated to increment its visit count N(s,a). The action-value of the edge is further updated to the mean evaluation over these simulations. The mean evaluation over these simulations is represented as Q(s,a)=1/N(s,a)Σ_{s′|s,a→s′}V(s′), where s,a↔s′ indicates that a simulation has reached s′ after taking move a from position s.

In some embodiments, the reinforcement learning model may be trained using a self-play algorithm. Such a self-play algorithm may be used in a game environment to allow the reinforcement learning model to teach itself a highly accurate generalized model for logistical prediction. In some embodiments, the reinforcement learning method may play itself ten times, one hundred times, one thousand times, ten thousand times, one hundred thousand times, over a million times, or any suitable number of times until a sufficient termination point is reached. In further embodiments, self-play is used along with the MCTS. In still further embodiments, the results of the self-play may be added to a training set. In even further embodiments, the reinforcement learning model may be periodically tested during training and continue training until the testing is satisfactory.

In some embodiments, the self-play may involve having a current best model play against a new potential challenger model. Both models will attempt to generate the best itinerary for a series of boards. In some embodiments, the models will compete ten times, one hundred times, one thousand times, ten thousand times, one hundred thousand times, over a million times, or any suitable number of times until a sufficient determination point is reached. At the conclusion of the competition, if the new potential challenger model has generated itineraries with a lower cost, the new potential challenger model may replace the current best model. This process also may repeat until a sufficient termination point is reached.

In some embodiments, the input to the neural network is a x by y by z image stack comprising z binary feature planes. (z-1)/2 feature planes Xₜ consist of binary values indicating the activity assignment status of a player's drivers (Xⁱₜ=1 if intersection i contains a driver assignment for the player at time-step t; 0 if the intersection is empty, or if t<0). A further (z-1)/2 feature planes Yₜ represent the corresponding features for the opponent player's driver assignment space. The last feature plane C represents the current player color, white or black, and maintains a constant value of either 1 if black is to play or 0 if white is to play. The planes are concatenated together to give input features sₜ=[Xₜ, Yₜ,Xₜ₋₁, Yₜ₋₁, . . . ,X_{t-((z-1)/2)}, Y_{t-((z-1)/2))},C]. Historical features Xₜ, Yₜ are included due to the nature of the logistics problem not being fully observable from only current driver assignments.

In some embodiments, the input features sₜ are processed by a residual tower consisting of a single convolutional clock followed by residual blocks. The convolutional block applies a convolution of 256 filters with kernel size 3×3 and stride 1; batch normalization; a rectified non-linear unit. Each residual block applies, sequentially to its input, a convolution of 256 filters of kernel size 3×3 with stride 1; batch normalization; a rectified non-linear unit; a convolution of 256 filters of kernel size 3×3 with stride 1; batch normalization; a skip connection for adding input to the block; a rectified non-linear unit. The output of the residual tower is passed to two separate heads for computing the policy and value, respectively. The policy head applies a convolution of 2 filters of kernel size 1×1 with stride 1; batch normalization; a rectified non-linear unit; a dense fully connected linear layer with output size x²+1, corresponding to logit probabilities for all intersections and a pass move. The value head applies a convolution of 2 filters of kernel size 1×1 with stride 1; batch normalization; a rectified non-linear unit; a dense fully connected linear layer to a hidden layer of size 256; a rectified non-linear unit; a dense fully connected linear layer to a scalar; and a tanh non-linearity outputting a scalar in the range [−1,1].

At step 304, the trained reinforcement learning model is used to train a supervised learning model. In some embodiments, both the inputs, the historical data, and the outputs, the itineraries produced by the reinforcement learning model, are used to train the supervised learning model. In further embodiments, the supervised learning model may be a recurrent neural network or any suitable deep learning model. For example, a Long Short Term Memory (LSTM) Encoder Decoder framework may be used for the supervised learning model. Alternatively or in addition, a gated current unit (GRU) or echo state network (ESN) framework may be used for the supervised learning model. In some embodiments, any neural network that makes predictions based on time series data may be used. In still further embodiments, the supervised learning model comprises an encoder-decoder framework that captures the inherent pattern in the labeled data, and a prediction network that takes input from the learned embedding from the encoder-decoder, in addition to given external features used to guide or stabilize the prediction.

At step 306, input requirements are given to the trained supervised learning model. The supervised learning model then generates an itinerary based on the input requirements. In some embodiments, the input requirements may be one or more of geographic coordinates, activities, activity start/end times, employees, employee clock-in/clock-out time, contractors, contractor clock-in/clock-out times, driver ratings, and vehicle type. In further embodiments, some of the requirements may be time sensitive. In some embodiments, the itinerary may initially be output as a series of geographic coordinates and corresponding paths. In further embodiments, the itinerary may further include time information.

At step 308, the generated itinerary is then sent to a user. In some embodiments, the itinerary may need to be processed before it is sent to the user, such that the itinerary is in a human-readable format. For example, the geographic coordinates within the itinerary may be translated into more relevant information, such as the name of a business located at the geographic coordinates. In further embodiments, the user may have requested multiple itineraries at once and may compile them before sending out the itineraries to multiple drivers. In still further embodiments, the driver may receive turn-by-turn navigation along with the itinerary. In even further embodiments, the driver may receive one or more tasks corresponding to one or more geographic locations within the itinerary.

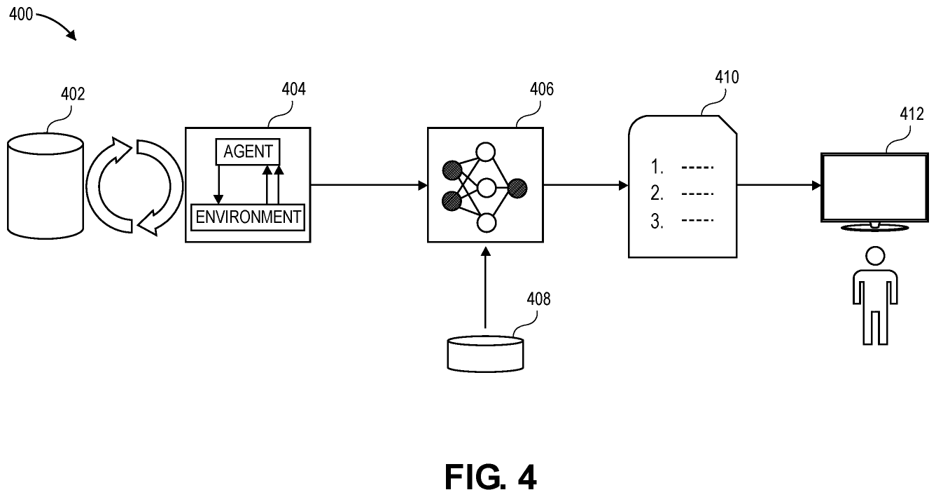

Turning now to FIG. 4, a schematic diagram 400 of an embodiment for generating an itinerary is depicted. Historical data 402 is used to train a reinforcement learning model 404. In some embodiments, the reinforcement learning model plays against itself to generate the lowest cost itinerary possible. In some embodiments, the historical data 402 may include geographic coordinates, activities, activity start/end times, employees, employee clock-in/clock-out time, contractors, contractor clock-in/clock-out times, driver ratings, and vehicle type.

In some embodiments, a subset of the historical data 402 may be selected randomly to be fed to the reinforcement learning model for training. In further embodiments, a generalized model may be trained on ten, twenty, fifty, one hundred, one thousand, or more datasets and inferred over unseen data. In other embodiments, an overfit model may be both trained and inferred on only one specific dataset or type of datasets.

The supervised learning model 406 is then trained using the inputs and outputs from the reinforcement learning model 404. In some embodiments, the supervised learning model 406 will be trained to minimize overhead costs. In further embodiments, the supervised learning model 406 uses a long short term memory encoder decoder framework. In still further embodiments, the supervised learning model 406 may include geo-location density optimization to anticipate how many drivers will be required at a certain location at a given time. In even further embodiments, the supervised learning model 406 may include multi-driver rideshare which allows the model to effectively pool together drivers, or have multiple active drivers be picked up and/or dropped off from a single vehicle, from same or differing locations in combined trips. In even more embodiments, the supervised learning model 406 may consider commercial driver's license requirements when optimizing the itinerary.

In some embodiments, training the supervised learning model 406 includes comparing the supervised learning 406 model to a prior model which involved human input. The prior model involving human input could be used to set a goal for the supervised learning model 406. While training, the supervised learning model 406 could be compared to the prior model, and if the prior model generated a better result, the supervised learning model 406 could be further trained. In some embodiments, the supervised learning model 406 would not be considered complete until the itineraries it generates have an equal or lower cost than the itineraries generated by the prior model involving human input.

Input requirements 408 are entered into the supervised learning mode 406. In some embodiments, the input requirements 408 may include geographic coordinates, activities, activity start/end times, employees, employee clock-in/clock-out time, contractors, contractor clock-in/clock-out times, driver ratings, and vehicle type. In further embodiments, the input requirements may include additional information which is not used directly by the machine learning model but is passed through to the driver. For example, input requirements may include tasks which the driver must complete at specific geographic coordinates.

The supervised learning model 406 generates an itinerary 410 based on the input requirements. In some embodiments, the itinerary 410 may be created for a particular driver. In further embodiments, the itinerary 410 may be generated for a particular car. The itinerary may include a series of geographic locations and corresponding times for when either a driver or car is expected to be at a particular location. In some embodiments, the itinerary may include a set path the driver should follow.

The itinerary 410 is sent to the user's device 412. In some embodiments, the user's device 412 may be the mobile phone of a driver. In further embodiments, turn-by-turn navigation will be provided along with the itinerary. Both the itinerary and the turn-by-turn navigation may be automatically updated if new input requirements 408 are submitted. In still further embodiments, an external data source may provide additional input requirements or information which may modify the itinerary. For example, external information relating to traffic, road closures, or weather may affect the itinerary and cause a new itinerary to be generated.

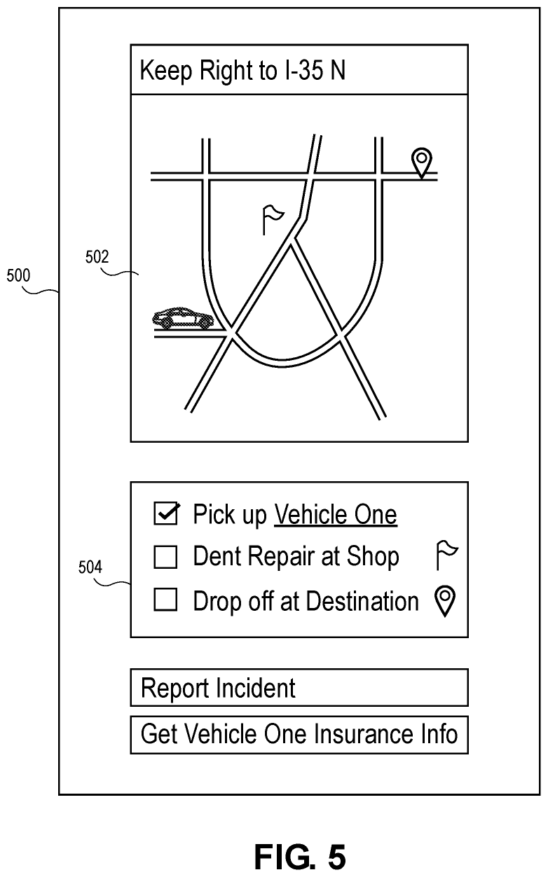

FIG. 5 depicts a driver interface in accordance with embodiments of the invention, and referred to broadly be reference numeral 500. Driver interface 500 may be implemented, in some embodiments, on the smartphone of a driver, and allows the driver to manage all aspects of individual trips as well as accepting bids for new trips, and submitting bills for completed trips, in addition to assisting the user to complete the itinerary as described above. In some embodiments, driver interface 500 allows for real-time, two-way communication between drivers and trip requestors, either by voice, video, messaging, or other communications channel. As described above driver interface 500 can notify the driver of received bids for trips. When the driver is conducting a trip, real-time turn-by-turn guidance can be provided using map 502. The driver interface 500 may allow for the itinerary to be directly displayed to the driver after it is generated.

Also provided is a checklist 504 of tasks to be completed by the driver at each location, also referred to herein as an “action sheet” for that driver. In some embodiments, tasks may be included along with the other input requirements and pass through to the driver. In further embodiments, the component pieces of the overall itinerary may be allocated among one or more drivers at specific locations. Each task may have a button for performing that task or indicating that the task has been performed. For example, a task of recording a video walk-around condition report for the car could have a button for triggering the start of video recording. A task to refuel the vehicle could include a button to provide payment information to a point-of-sale device or capture an image of a receipt for later reimbursement. Similarly, if a vehicle (e.g., a moving truck) is dropped off at a client's house, a button can be provided to capture the client's signature affirming that they received the vehicle. Many such tasks can be combined into an action sheet for a particular location if needed. In some embodiments, the driver indicating that a task has been completed may trigger the machine learning model to generate an updated itinerary. Some tasks, such as drop off or repair tasks, may simply have a checkbox to indicate that they have been completed. Action sheets for each driver can automatically be created based on the vehicle, the location, and/or other factors of the trip. For example, an item may automatically be added to an action sheet to pick up the title (and/or other documentation) at the initial pick-up location for a vehicle. Similarly, if a vehicle is dropped off at a rail yard for further transportation via train, an action item may be automatically added to fold in the vehicle's mirrors when dropping it off. In some embodiments, “dispatch action sheets” may be available for drivers, which simply instruct the drivers to show up at an initial pick-up location for subsequent assignment (which may be verbally or via later addition of additional items to their action sheet). In some embodiments, certain tasks can only be completed at certain locations. For example, an oil change may only be able to be completed at a mechanic. In some embodiments, the driver's location may be used to confirm that the driver is at an appropriate location when the task is marked as complete.

As discussed above, embodiments of the invention are discussed in this specification with respect to the transportation of personal vehicles for the sake of brevity. However, the invention is applicable to many more industries, and each industry will have its own set of applicable tasks for inclusion in action sheets. For example, action sheets can be used in any industry where temporary labor is needed. In such an industry, items on an action sheet might include “report to the job site,” “check out truck,” “collect team members,” “purchase job materials,” and so on. Furthermore, additional tasks may be applicable across multiple industries, such as upselling the customers or the surveys described elsewhere.

Similarly, the system can be used for the transportation and use of heavy equipment (e.g., construction equipment such as backhoes, digger derricks, and aerial lifts, or commercial vehicles such as moving trucks or tow trucks). In such industries, action sheets might include items such as “load equipment onto trailer,” “pick up escort vehicles,” “transport equipment to job site,” “don safety gear,” and so on. Of course, in such an embodiment, when the operators of the heavy equipment (i.e., drivers as discussed elsewhere) are selected for such trips, only drivers licensed to operate the corresponding equipment are considered for selection.

Still other embodiments of the invention can be used for transporting vehicles such as airplanes. In such embodiments, existing pre-flight checklists can be incorporated into action sheets. Thus, an action sheet might include elements such as “pick up airport gate pass,” “travel to airport,” and “arrive at hanger” as well as traditional pre-flight checks such as “verify that ARROW documents are present,” “perform aircraft walk around,” “verify control rigging,” etc.

Interface 500 can also provide documentation needed for the trip. For example, where the trip requestor has provided by-the-trip automobile insurance, the details of that policy can be provided to the driver via interface 500. Similarly, if a digital license plate number has been assigned to the vehicle for the trip, the plate number can be provided to the driver by interface 500 for reference or entry onto a digital license plate display. Where the trip requestor has made provision for third-party transportation (e.g., a taxi or car-sharing service) to or from the initial pick-up or final drop-off locations, driver interface 500 can be used to summon the transportation when it is needed. This information may be automatically modified if an updated itinerary is generated by the supervised learning model.

When the driver is not currently engaged in a trip, driver interface 500 can provide a variety of different functionality. For example, car manufacturers may wish to survey particular demographics of drivers as to their opinion of certain models of cars. Thus, for example, Ford might wish to know how male drivers 18-20 feel about the cabin interior of the 2015 F-150. Once this request is entered into the system, any drivers matching the desired demographics can be presented with the appropriate survey in interface 500 whenever they have finished transporting the corresponding vehicle. In some embodiments, such information may be used as additional input requirements for one or more of the machine learning models.

In some embodiments, funds can automatically be transferred to driver's accounts when they indicate that they have finished a trip or once the destination signs off. This payment information can be collected for display in driver interface 500 as well, as well as exported for use by, for example, a tax professional preparing a tax return for the driver. Similarly, the driver may be able to use interface 500 to schedule or manually indicate their availability to transport vehicles so that they only receive bids when they are prepared to work. Interface 500 can also be used by a driver to provide feedback about any aspect of the trip, including the trip requestor, the pick-up, drop-off or intermediate facilities or the vehicles being transported. When needed, interface 500 can also be used to complete certifications requested by trip creators or verify licensing information. Of course, one of skill in the art will appreciate that the functionality of interface 500 can further be adapted for use with any by-the-job employment, such as day laborers, personal assistants, etc.

Many different arrangements of the various components depicted, as well as components not shown, are possible without departing from the scope of the claims below. Embodiments of the invention have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims. Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A system for generating a vehicle transportation itinerary, comprising:
a first server, programmed to:
receive historical data comprising a series of vehicle trips comprising a starting location, an ending location, and a distance traveled;
train a reinforcement learning model to generate a schedule based on a cost function associated with the schedule, wherein the reinforcement learning model is trained on the historical data using a self-play algorithm;
use the reinforcement learning model to generate a plurality of schedules;
train a supervised learning model using the historical data and the plurality of schedules;
generate the itinerary using the supervised learning model by providing it with a set of input requirements, wherein the set of input requirements comprises a plurality of geographic coordinates and a map of the road network between the geographic coordinates; and
transmit the itinerary to a user.

2. The system of claim 1, wherein the first server is further programmed to:
send instructions for displaying the itinerary to the user; and
send instructions for providing turn-by-turn navigation for each location on the itinerary.

3. The system of claim 2, wherein the set of input requirements further comprises a set of actions to be performed at one or more of the geographic coordinates, and wherein the itinerary includes the set of actions.

4. The system of claim 1, wherein the first server is further programmed to:
query an external data source to receive external data; and
generate an updated itinerary based on the external data.

5. The system of claim 1, wherein the set of input requirements further comprises one or more of a set of activities, activity start/end times, employees, employee clock-in/clock-out times, contractors, contractor clock-in/clock-out times, driver ratings, and vehicle types.

6. The system of claim 1, wherein the supervised learning model is a neural network using a long short term memory encoder-decoder framework.

7. The system of claim 1, wherein the first server is further programmed to:
receive updated input requirements;
generate an updated itinerary based on the updated input requirements; and
send the updated itinerary to the user.

8. One or more non-transitory computer-readable media storing computer-executable instructions that, when executed by a processor, perform a method of generating a vehicle transportation itinerary, the method comprising the steps of:
receiving historical data comprising a series of vehicle trips comprising a starting location, an ending location, and a distance traveled;
training a reinforcement learning model to generate a schedule based on a cost function associated with the schedule, wherein the reinforcement learning model is trained on the historical data using a self-play algorithm;
using the reinforcement learning model to generate a plurality of schedules;
training a supervised learning model using the historical data and the plurality of schedules;
generating the itinerary using the supervised learning model by providing it with a set of input requirements, wherein the set of input requirements comprises a plurality of geographic coordinates and a map of the road network between the geographic coordinates; and
transmitting the itinerary to a user.

9. The computer-readable media of claim 8, wherein the method further comprises the steps of:
sending instructions for displaying the itinerary to the user; and
sending instructions for providing turn-by-turn navigation for each location on the itinerary.

10. The computer-readable media of claim 9, wherein the set of input requirements further comprises a set of actions to be performed at one or more of the geographic coordinates, and wherein the itinerary includes the set of actions.

11. The computer-readable media of claim 8, wherein the method further comprises the steps of:
querying an external data source to receive external data; and
generating an updated itinerary based on the external data.

12. The computer-readable media of claim 8, wherein the set of input requirements further comprises one or more of a set of activities, activity start/end times, employees, employee clock-in/clock-out times, contractors, contractor clock-in/clock-out times, driver ratings, and vehicle types.

13. The computer-readable media of claim 8, wherein the supervised learning model is a neural network using a long short term memory encoder-decoder framework.

14. The computer-readable media of claim 8, wherein the method further comprises the steps of:
receiving updated input requirements;
generating an updated itinerary based on the updated input requirements; and
sending the updated itinerary to the user.

15. A method for generating a vehicle transportation itinerary, comprising the steps of:
receiving historical data comprising a series of vehicle trips comprising a starting location, an ending location, and a distance traveled;
training a reinforcement learning model to generate a schedule based on a cost function associated with the schedule, wherein the reinforcement learning model is trained on the historical data using a self-play algorithm;
using the reinforcement learning model to generate a plurality of schedules;
training a supervised learning model using the historical data and the plurality of schedules;
generating the itinerary using the supervised learning model by providing it with a set of input requirements, wherein the set of input requirements comprises a plurality of geographic coordinates and a map of the road network between the geographic coordinates; and
transmitting the itinerary to a user.

16. The method of claim 15, further comprising the steps of:
sending instructions for displaying the itinerary to the user; and
sending instructions for providing turn-by-turn navigation for each location on the itinerary.

17. The method of claim 16, wherein the set of input requirements further comprises a set of actions to be performed at one or more of the geographic coordinates, and wherein the itinerary includes the set of actions.

18. The method of claim 15, wherein the set of input requirements further comprises one or more of a set of activities, activity start/end times, employees, employee clock-in/clock-out times, contractors, contractor clock-in/clock-out times, driver ratings, and vehicle types.

19. The method of claim 15, wherein the supervised learning model is a neural network using a long short term memory encoder-decoder framework.

20. The method of claim 15, further comprising the steps of:
receiving updated input requirements;
generating an updated itinerary based on the updated input requirements; and
sending the updated itinerary to the user.
